(19) United States
(12) Patent Application Publication
(10) Pub. No.: US 2021/0377048 A1
(43) Pub. Date: Dec. 2, 2021

(54) Digital Signature Method, Signature Information Verification Method, Related Apparatus and Electronic Device

(71) Applicant: Beijing Baidu Netcom Science and Technology Co., Ltd., Beijing (CN)

(72) Inventors: Yuao CHEN, Beijing (CN); Runyao DUAN, Beijing (CN); Lijing JIN, Beijing (CN)

(21) Appl. No.: 17/366,679

(22) Filed: Jul. 2, 2021

(30) Foreign Application Priority Data
Dec. 17, 2020 (CN) 202011493443.0

(51) Int. Cl. H04L 9/32; H04L 9/08

(52) U.S. Cl. CPC H04L 9/3247; H04L 9/3263; H04L 9/0869

(57) ABSTRACT

This application discloses a digital signature method, a signature information verification method, a related apparatus and an electronic device, and relates to the field of information security in quantum computing. The digital signature method includes: acquiring a to-be-sent file and a private key used by a first electronic device for digital signature, where the private key includes a first invertible matrix; generating, based on a randomly generated second invertible matrix and a first tensor, a second tensor isomorphic to the first tensor; using a hash function to digitally sign the to-be-sent file based on the second tensor, to obtain a first character string; generating, based on the first character string, the first invertible matrix and the second invertible matrix, signature information provided by the first electronic device for the to-be-sent file.

### CROSS-REFERENCE TO RELATED APPLICATION

The present application claims priority to Chinese patent application No. 202011493443.0 filed in China on Dec. 17, 2020, a disclosure of which is incorporated herein by reference in its entirety.

### TECHNICAL FIELD

The present application relates to the field of quantum computing technology, in particular to the field of information security in quantum computing, and relates specifically to a digital signature method, a signature information verification method, a related apparatus and an electronic device.

### BACKGROUND

Digital signature is a basic public key cryptography task. Public key cryptography means that the cryptographic scheme contains a public key and a private key. The public key can be made public, so that two users can perform encryption, decryption, and identity authentication without establishing communication therebetween. The goal of digital signature is to authenticate a sender of a file, so as to ensure that the sender of the file is authentic, which is of fundamental importance in e-commerce and Internet protocols.

Conventionally, in Internet communications, digital signature schemes commonly used are based on the hardness of large number decomposition and discrete logarithms, such as the asymmetric encryption algorithm based on Diffie-Hellman key exchange.

### SUMMARY

The present disclosure provides a digital signature method, a signature information verification method, a related apparatus and an electronic device.

A first aspect of the present disclosure provides a digital signature method applied to a first electronic device, including acquiring a to-be-sent file and a private key used by the first electronic device for digital signature, where the private key includes a first invertible matrix. The method also includes generating, based on a randomly generated second invertible matrix and a first tensor, a second tensor isomorphic to the first tensor, and using a hash function to digitally sign the to-be-sent file based on the second tensor, to obtain a first character string. The method further includes generating, based on the first character string, the first invertible matrix and the second invertible matrix, signature information provided by the first electronic device for the to-be-sent file.

A second aspect of the present disclosure provides a signature information verification method applied to a second electronic device that includes acquiring a to-be-sent file, signature information of the to-be-sent file, and a public key used by the second electronic device to verify the signature information, where the public key corresponds to a private key associated with the signature information, and the public key includes a third tensor. The method also includes generating a fourth tensor based on the signature information and the third tensor included in the public key, and using a hash function to digitally sign the to-be-sent file based on the fourth tensor to obtain a second character string. The method further includes verifying the signature information based on the second character string.

A third aspect of the present disclosure provides a digital signature apparatus applied to a first electronic device, including a first acquisition module configured to acquire a to-be-sent file and a private key used by the first electronic device for digital signature, where the private key includes a first invertible matrix. The apparatus also includes a first generating module, configured to generate, based on a randomly generated second invertible matrix and a first tensor, a second tensor isomorphic to the first tensor, and a first digital signature module, configured to use a hash function to digitally sign the to-be-sent file based on the second tensor, to obtain a first character string. The apparatus also includes a second generating module, configured to generate, based on the first character string, the first invertible matrix and the second invertible matrix, signature information provided by the first electronic device for the to-be-sent file.

A fourth aspect of the present disclosure provides a signature information verification apparatus applied to a second electronic device, including a second acquisition module, configured to acquire a to-be-sent file, signature information of the to-be-sent file, and a public key used by the second electronic device to verify the signature information, where the public key corresponds to a private key associated with the signature information, and the public key includes a third tensor. The apparatus also includes a fifth generating module, configured to generate a fourth tensor based on the signature information and the third tensor included in the public key, and a second digital signature module, configured to use a hash function to digitally sign the to-be-sent file based on the fourth tensor, to obtain a second character string. The apparatus further includes a verifying module, configured to verify the signature information based on the second character string.

A fifth aspect of the present disclosure provides an electronic device, including at least one processor; and a memory communicatively connected to the at least one processor. The memory stores instructions executable by the at least one processor, and the instructions are executed by the at least one processor, so that the at least one processor implements the method according to the first aspect, or the method according to the second aspect.

A sixth aspect of the present disclosure provides a non-transitory computer-readable storage medium storing therein a computer instruction, wherein the computer instruction is configured to cause the computer to implement the method according to the first aspect, or the method according to the second aspect.

A seventh aspect of the present disclosure provides a computer program product. When the computer program product is run on an electronic device, the electronic device implements the method according to the first aspect, or the method according to the second aspect.

It should be understood that the content described in this section is not intended to identify the key or important features of the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to better understand the solution, and do not constitute a limitation on the present application.

FIG. 1 is a schematic flowchart of a digital signature method according to a first embodiment of the present application;

FIG. 2 is a schematic flowchart of a signature information verification method according to a second embodiment of the present application;

FIG. 3 is a schematic structural diagram of a digital signature apparatus according to a third embodiment of the present application;

FIG. 4 is a schematic structural diagram of a signature information verification apparatus according to a fourth embodiment of the present application; and

FIG. 5 shows a schematic block diagram of an example electronic device 500 that can be used to implement the embodiments of the present disclosure.

### DETAILED DESCRIPTION

The following describes exemplary embodiments of the present application with reference to the accompanying drawings, which include various details of the embodiments of the present application to facilitate understanding, and should be regarded as merely exemplary. Therefore, those of ordinary skill in the art should recognize that various changes and modifications can be made to the embodiments described herein without departing from the scope and spirit of the present disclosure. Likewise, for clarity and conciseness, descriptions of well-known functions and structures are omitted in the following description.

### First Embodiment

As shown in FIG. 1, the present application provides a digital signature method applied to a first electronic device, including following steps S101 to S104.

Step S101: acquiring a to-be-sent file and a private key used by the first electronic device for digital signature, where the private key includes a first invertible matrix.

In this embodiment, the digital signature method relates to the field of quantum computing technology, and in particular to the field of information security in quantum computing, and can be widely used in many scenarios such as e-commerce, identity authentication, and software distribution.

For example, in the application scenario of identity authentication, suppose that Party A needs to send a file to Party B, and Party B needs to verify that this file is indeed sent by Party A and not by someone else. At this point, Party A can digitally sign this file, and after receiving the file and the corresponding signature information and obtaining the public key publicly broadcast by Party A, Party B can verify that the sender of this file is indeed Party A.

For another example, in the application scenario of software distribution, publisher authentication can be performed on the obtained software to determine the source of the software.

In actual use, the digital signature method of the embodiment of the present application may be implemented by the digital signature apparatus of the embodiment of the present application. The digital signature apparatus of the embodiment of the present application may be provided in any first electronic device to implement the digital signature method of the embodiment of the present application. The first electronic device may be a server or a terminal, which is not specifically limited here.

As the sender of communication, the first electronic device can communicate with other electronic devices to send files. Before sending the file, in order to enable other electronic devices to verify that the received file was indeed sent by the first electronic device, i.e., verify the authenticity of the sender, the first electronic device may use digital signature technology to digitally sign the to-be-sent file.

The “to-be-sent” file in this embodiment means a file that the first electronic device needs to send to other electronic devices, and its type may be text, compressed package, audio, video, or the like.

The private key may be a parameter pre-stored by the first electronic device, and used for encrypting and digitally signing a to-be-sent file of the first electronic device. The private key may correspond to the public key, and the combination of the private key and the public key may be called a key pair, and the public key is usually shared by other electronic devices with other electronic devices, so that other electronic devices can use the public key to perform decryption and signature parsing on the signature information of the first electronic device.

As a task in public key cryptography, digital signature schemes need to be based on the hardness of a certain algorithm problem to ensure the security of digital signatures. With the development of quantum computers, the algorithmic problems that the existing digital signature schemes are based on are usually not difficult for quantum computers, that is, the algorithmic problems that the existing digital signature schemes are based on may not be able to resist quantum attacks. Therefore, the security of digital signatures is threatened.

The hardness mentioned above is a subtle concept. First of all, different from the generally considered worst-case hardness, what is needed here is average-case hardness, that is, there is no valid algorithm for most inputs. Secondly, because not all hard algorithms correspond to a suitable digital signature protocol, it is necessary to design a corresponding protocol based on the problem. Finally, we need to explore, from the perspective of quantum algorithm design, the availability of this problem in the context of post-quantum cryptography; for example, although the problem of large number decomposition is hard from the perspective of classical computers, it is easy from the perspective of quantum computing.

From the perspective of computational complexity, the tensor isomorphism problem may be regarded as a harder problem among the problems of isomorphism type. From the perspective of quantum computing, due to the hardness of solving tensor isomorphism problem, digital signatures designed based on tensor isomorphism problem guarantee the security from the perspective of quantum algorithms Therefore, in the embodiments of the present application, the algorithm problem that the digital signatures are based on may use the tensor isomorphism problem, that is, the hardness for most computers (including quantum computers) to solve the tensor isomorphism problem is used to design digital signatures.

The tensor isomorphism problem is described in the following.

Let P be a prime number, GF(p) denotes a modulo P domain, and GL(n, p) denotes a set of invertible matrices having a size of n×n in GF(p). A multi-order matrix in GF(p) can be called a tensor, where the order of the tensor is usually greater than 2.

Taking a tensor being a third-order matrix as an example, the tensor can be called a matrix of n×n×n, which has n×n×n components, n can be called the dimension of the tensor. Let one tensor be A, denoted by A=(aᵢⱼₖ), and let another tensor be B, denoted by B=(bᵢⱼₖ), the length of each order of data is n, that is, the subscript i, j and k of the tensors separately range from 1 to n, which is denoted by i,j,kϵ{1, 2, . . . , n}, and aᵢⱼₖ, bᵢⱼₖϵGF(p) are elements of the i^{th} sheet, j^{th} row, and k^{th} column of the two tensors respectively, and the elements can be enumerated to form the tensors, i.e., (aᵢⱼₖ) and (bᵢⱼₖ). The tensor isomorphism problem is to solve whether there is an invertible matrix, denoted by C=(cᵢⱼ)ϵGL(n, p), such that A=(C, C, C)°B In other words, the tensor isomorphism problem is to determine whether two tensors are isomorphic to each other, and in the case that the two tensors are isomorphic to each other, find the invertible matrix of the mutual transformation of the two tensors.

The “°” in the formula (C, C, C)°B means that the tensor are multiplied by three matrices in three directions of the tensor respectively, that is to say, three matrices can be multiplied in the three directions of the tensor at the same time, and the three matrices can be a same invertible matrix C. The result of the multiplication is also a tensor, which can be represented by B′, where B′=(b′ᵢⱼₖ), and b′ᵢⱼₖ is a number in the tensor B′ at a position corresponding to the subscripts, and b′ᵢⱼₖ=Σₒ₌₁ⁿcᵢₒ(Σ_{q=1}ⁿc_{jq}(Σᵥ₌₁ⁿcₖᵥb_{oqv}))=Σ_{oqv}cᵢₒc_{jq}cₖᵥb_{oqv}.

It should be noted that in the case that the tensor is a higher-order matrix, the tensor isomorphism problem can also be extended to a tensor which is a higher-order matrix, that is, the tensor isomorphism problem of higher-order matrices can be analogized based on the tensor isomorphism problem of the third-order matrix. For example, for two tensors that are fourth-order matrices, which can be represented by A=(aᵢⱼₖ) and B=(bᵢⱼₖₗ) respectively, the tensor isomorphism problem refers to whether there is an invertible matrix C, such that A=(C, C, C, C)°B.

Under the premise of the tensor isomorphism problem, it is hard to find the invertible matrix of the transformation between two tensors even it is known that the two tensors are isomorphic to each other. Therefore, in order to ensure the security of digital signatures, the private key used by the first electronic device for digital signature can be configured as a matrix form, to ensure the hardness of cracking the private key.

Specifically, the private key may include a first invertible matrix, and the public key may be configured as a tensor form, and the public key is published. In this way, if other electronic devices need to forge the signature information provided by the first electronic device for the to-be-sent file, they need to crack the private key based on the public key, which is equivalent to that which other electronic devices need to solve a tensor isomorphism problem. Due to the hardness of solving the tensor isomorphism problem, it is difficult for other electronic devices to crack the private key of the first electronic device based on the public key. Therefore, it is difficult for other electronic devices to forge the signature of the first electronic device, thus the security of digital signatures may be guaranteed.

In practical applications, based on the tensor isomorphism problem, an identity authentication protocol can be constructed using the zero-knowledge interaction protocol of classic graph isomorphism problem. According to the required security, the protocol can be performed several rounds, and multiple tensors are generated in each round. Based on the identity authentication protocol, a digital signature scheme can be constructed using the classic identity recognition protocol Fiat-Shamir conversion process.

According to the main parameters in the protocol (for example, n is the number of dimensions of the tensor, p is the domain size, r is the number of rounds, t is the number of tensors generated in each round), and understanding of the best algorithm running time for the tensor isomorphism problem, appropriate parameters can be selected to achieve the required security of digital signatures, for example, to achieve 128 bit security or 256 bit security.

The to-be-sent file can be acquired in multiple ways. For example, the to-be-sent file can be acquired from a pre-stored file. For another example, the to-be-sent file can be generated actively.

The private key may be pre-generated by the first electronic device and stored in the database, or it may be preset and stored in a database by the developer, which is not specifically limited here.

Take the private key being pre-generated and stored in the database by the first electronic device as an example. The first electronic device may randomly generate at least one first invertible matrix, e.g., randomly generate t−1 first invertible matrices, which are represented by Cᵢ ϵGL(n, p), iϵ{1, 2, . . . t−1}, where t can be set according to the actual situation, and t is greater than or equal to 2. The private key of the first electronic device may include a plurality of invertible matrices, which may be C₀, C₁, . . . , Cₜ₋₁, where C₀ is an identity matrix with a size of n.

Step S102: generating, based on a randomly generated second invertible matrix and a first tensor, a second tensor isomorphic to the first tensor.

Taking designing a digital signature scheme by using the tensor isomorphism problem of a third-order matrix as an example, when the private key and public key of the first electronic device are constructed, a first tensor can be randomly generated, which can be denoted as A₀, and the first tensor A₀=(aᵢⱼₖ), i,j,kϵ{1, 2, . . . , n}, aᵢⱼₖϵGF(p). The first tensor can be used as an initial tensor for tensor isomorphism, and can be used as a part of the public key.

For iϵ{1, . . . , r}, where r may be a positive integer, the first electronic device may randomly generate at least one second invertible matrix, and the at least one second invertible matrix may be represented by DᵢϵGL(n, p). That is to say, based on the randomly generated second invertible matrix and the first tensor, at least one second tensor isomorphic to the first tensor may be constructed, and the formula for constructing the second tensor can be Bᵢ=(Dᵢ, Dᵢ, Dᵢ)°A₀, iϵ{1, . . . , r}.

Step S103: using a hash function to digitally sign the to-be-sent file based on the second tensor, to obtain a first character string.

A hash function (denoted by H) can be used to digitally sign the to-be-sent file (denoted by M). Specifically, the to-be-sent file M can be concatenated with the second tensors B₁, . . . , Bᵣ as a character string, and then, a hash operation is performed on the concatenated character string to obtain a first character string, which is denoted by H(M|B₁| . . . |Bᵣ).

M|B₁| . . . |Bᵣ means that the to-be-sent file M is concatenated with the second tensors B₁, . . . , Bᵣ as a character string. The first character string may be a binary character string, that is, a character string of characters ‘0’ and ‘1’, its length can be r*s. The parameter s is also a parameter of the identity authentication protocol, and the parameters s and t meet t=2^{s}. H is a hash function, the input thereof can be a character string of any length, while a character string outputted from the hash function has a length of r*s, and is a character string of characters ‘0’ and ‘1’.

Step S104: generating, based on the first character string, the first invertible matrix and the second invertible matrix, signature information provided by the first electronic device for the to-be-sent file.

The signature information provided by the first electronic device for the to-be-sent file may be generated based on the first character string, the first invertible matrix, and the second invertible matrix. The signature information may include the first character string, and a target matrix generated from the first character string, the first invertible matrix, and the second invertible matrix. In an optional implementation, the signature information may include a plurality of character strings segmented from the first character string, and a target matrix generated from the plurality of character strings, the first invertible matrix and the second invertible matrix.

In this embodiment, by configuring the private key of the first electronic device in the form of an invertible matrix, and constructing a second tensor that is isomorphic to the initial tensor from the randomly generated second invertible matrix and the initial tensor, the to-be-sent file is digitally signed based on the second tensor using the hash function. In this way, if other electronic devices need to forge the signature information provided by the first electronic device for the to-be-sent file, they need to crack the private key based on the public key, which is equivalent to that other electronic devices need to solve a tensor isomorphism problem. Due to the hardness of solving the tensor isomorphism problem, it is difficult for other electronic devices to crack the private key of the first electronic device based on the public key. Therefore, it is difficult for other electronic devices to forge the signature of the first electronic device, thus the security of digital signatures may be guaranteed.

Optionally, the step S104 specifically includes:

segmenting the first character string to obtain P character strings, where P is a positive integer greater than 1;

generating a target matrix based on the P character strings, the first invertible matrix and the second invertible matrix;

wherein, the signature information includes the P character strings and the target matrix.

In this implementation, the first character string can be segmented to obtain multiple character strings, for example, to obtain r character strings of characters ‘0’ and ‘1’ which each has a length s, and the r character strings can be denoted as f₁, . . . , fᵣ respectively, in this case, r is greater than 1.

The target matrix may be generated based on the P character strings, the first invertible matrix, and the second invertible matrix. Specifically, for iϵ{1, . . . , r}, the first electronic device may use a formula Eᵢ=DᵢC_{f}_{ᵢ}⁻¹ to calculate the target matrix, where Eᵢ is the target matrix, and there may be multiple target matrices, C_{f}_{ᵢ}⁻¹ denotes the inverse matrix of the fᵢ-th invertible matrix in the private key. For example, when the fᵢ is 1, C_{f}_{ᵢ}⁻¹ is the inverse matrix of the invertible matrix C₁ in the private key, that is, the target matrix can be obtained from matrix multiplication of the second invertible matrix Dᵢ and the inverse matrix of the invertible matrix C_{f}_{ᵢ} in the private key.

Finally, based on the r character strings and the multiple target matrices, the signature information provided by the first electronic device for the to-be-sent file can be determined, and the signature information is (f₁, . . . , fᵣ, E₁, . . . , Eᵣ).

If another electronic device, such as a third electronic device, wants to pretend to be the first electronic device and wants to generate a signature for the to-be-sent file M, since the third electronic device does not have the private key, it cannot generate a target matrix based on the private key, that is, it cannot use the formula Eᵢ=DᵢC_{f}_{ᵢ}⁻¹ to generate the target matrices E₁, . . . , Eᵣ, in the meantime, cracking the private key requires solving a tensor isomorphism problem, so it is difficult for the third electronic device to obtain the private key of the first electronic device.

In addition, any direct attack method of the third electronic device against the protocol will amount to the following problem: the third electronic device needs to find a way to generate multiple character strings of characters ‘0’ and ‘1’, i.e., g₁, . . . , gᵣϵ{0, 1, . . . , t−1}, such that after calculating Bᵢ=(Dᵢ, Dᵢ, Dᵢ)°A_{g}_{ᵢ}, iϵ{1, . . . , r}, for all iϵ{1, . . . , r}, the f₁, . . . , fᵣ obtained from the calculation of H(M|B₁| . . . |Bᵣ) satisfy fᵢ=gᵢ. However, according to the nature of hash function, the success probability of such an attack will not significantly exceed ½^{rs}.

Therefore, based on the above two points, it is very difficult for the third electronic device to forge the signature information of the first electronic device.

Further, the parameter combination in the protocol can be configured as follows to achieve 128 bit security, as shown in Table 1 below.

TABLE 1
Some parameter combinations to achieve 128 bit security

| | | | | | Public key | Signature |
|---|---|---|---|---|---|---|
| | | | | | length | length |
| | n | p | r | s | (Bytes) | (Bytes) |
| Combination 1 | 9 | 8191 | 128 | 1 | 2396 | 16864 |
| Combination 2 | 9 | 8191 | 16 | 8 | 303264 | 2122 |
| Combination 3 | 9 | 8191 | 21 | 6 | 75816 | 2780 |

In this implementation, the first character string is segmented to obtain P character strings, and a target matrix is generated based on the P character strings, the first invertible matrix, and the second invertible matrix, and finally the signature information including the P character strings and the target matrix is obtained. In this way, by using a randomly generated second invertible matrix and public and private keys to generate a signature, it is very difficult for other electronic devices, without knowing the private key, to forge the invertible matrix between multiple known tensors based on the multiple known tensors, i.e., forge the private key, which makes it very difficult to forge the digital signature, and then the security of the digital signatures can be improved.

Optionally, before the step S101, the method further includes:

generating, based on the first invertible matrix and the first tensor, a third tensor isomorphic to the first tensor;

generating a public key including the first tensor and the third tensor, where the public key corresponds to the private key;

publishing the public key.

This implementation is a process of generating a public key based on a private key, and in order to enable other electronic devices to authenticate the sender of the to-be-sent file, that is, the first electronic device, in the case that the signature information and the to-be-sent file sent by the first electronic device are received, the public key corresponding to the private key needs to be published.

The private key includes a first invertible matrix CᵢϵGL(n, p), iϵ{1, 2, . . . , t−1} and an identity matrix C₀ with a size of n, and a third tensor isomorphic to the first tensor can be generated based on the first invertible matrix and the first tensor, and the public key may include the first tensor and the third tensor, and the third tensor may be denoted as Aᵢ, iϵ{1, . . . , t−1}.

Specifically, a third tensor isomorphic to the first tensor may be generated based on the formula Aᵢ=(Cᵢ, Cᵢ, Cᵢ)°A₀, iϵ{1, . . . , t−1}, and the public key of the first electronic device may include the first tensor and the third tensor, that is, A₀, A₁, . . . , Aₜ₋₁.

Thereafter, the generated public key can be published, and correspondingly, other electronic devices can obtain the public key of the first electronic device.

In this implementation, the private key and the randomly generated initial tensor are used to construct the third tensor isomorphic to the initial tensor, and the initial tensor and the third tensor are published as the public key of the first electronic device. In this way, by configuring the public key in the form of isomorphic tensors, other electronic devices can only parse the signature information of the first electronic device based on the public key published by the first electronic device, to verify the identity of the first electronic device, and it is very difficult to crack the invertible matrix between isomorphic tensors, that is, the private key, based on the isomorphic tensors in the public key, which is equivalent to solving a tensor isomorphism problem, therefore the security of digital signatures can be improved and quantum computer attack can be effectively resisted.

### Second Embodiment

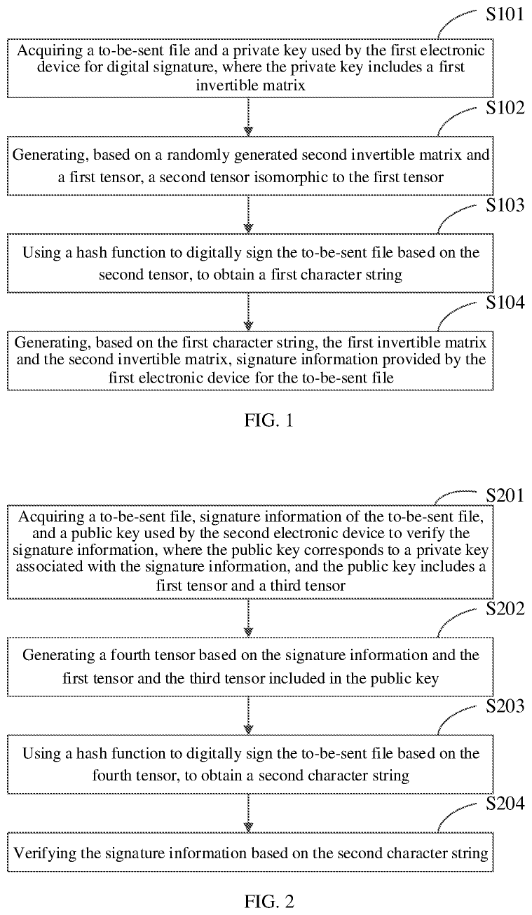

As shown in FIG. 2, the present application provides a signature information verification method applied to a second electronic device, including following steps S201 to S204.

Step S201: acquiring a to-be-sent file, signature information of the to-be-sent file, and a public key used by the second electronic device to verify the signature information, where the public key corresponds to a private key associated with the signature information, and the public key includes a first tensor and a third tensor;

Step S202: generating a fourth tensor based on the signature information and the first tensor and the third tensor included in the public key;

Step S203: using a hash function to digitally sign the to-be-sent file based on the fourth tensor, to obtain a second character string;

Step S204: verifying the signature information based on the second character string.

In this embodiment, the second electronic device is an electronic device that receives the to-be-sent file, and the first electronic device can send the to-be-sent file and the signature information of the to-be-sent file to the second electronic device. Correspondingly, the second electronic device can receive the to-be-sent file and the signature information of the to-be-sent file.

Before sending the to-be-sent file and the signature information of the to-be-sent file, the first electronic device will publish the public key for verifying its identity. Correspondingly, the second electronic device can acquire the public key published by the first electronic device.

The public key corresponds to the private key associated with the signature information, that is, the public key and the private key used to generate the signature information are a key pair, and the public key may include the third tensor and an initial tensor randomly generated by the first electronic device.

A fourth tensor may be generated based on the signature information and the first tensor and the third tensor included in the public key. The fourth tensor can be denoted as B′ᵢ. Specifically, for iϵ{1, . . . , r}, the second electronic device can use a formula B′ᵢ=(Eᵢ, Eᵢ, Eᵢ)°A_{f}_{ᵢ} to generate at least one fourth tensor.

Thereafter, based on the fourth tensor, a hash function may be used to digitally sign the to-be-sent file, to obtain a second character string. Specifically, the to-be-sent file M can be concatenated with the fourth tensors B′₁, . . . , B′ᵣ as a character string, and then, a hash operation is performed on the concatenated character string to obtain the second character string, which is denoted as H(M|B′₁| . . . |B′ᵣ).

M|B′₁| . . . |B′ᵣ means that the to-be-sent file M is concatenated with the fourth tensors B′₁, . . . , B′ᵣ as a character string, the second character string may be a binary character string, that is, a character string of characters ‘0’ and ‘1’, and its length can be r*s.

Finally, the signature information may be verified based on the second character string. In the case that the second character string is exactly the same as the character string in the signature information, the signature information verification succeeds, that is, the to-be-sent file is indeed sent by the first electronic device. In the case that the second character string is not exactly the same as the character string in the signature information, the signature information verification fails, that is, the to-be-sent file is sent by an electronic device other than the first electronic device.

In this embodiment, a fourth tensor is generated based on the tensors in the public key and the signature information, and based on the fourth tensor, a hash function is used to digitally sign the to-be-sent file to obtain the second character string; the signature information is verified based on the second character string. In this way, when the second electronic device obtains the public key published by the first electronic device, based on the public key and the received to-be-sent file and signature information of the to-be-sent file, the second electronic device can verify the signature information very conveniently, to verify the identity of the sender of the to-be-sent file.

Optionally, the signature information includes P character strings, where P is a positive integer greater than 1, and the step S204 specifically includes:

segmenting the second character string to obtain M character strings, where P is equal to M;

in the case that the P character strings are equal to the M character strings in a one-to-one manner, determining that the signature information verification succeeds; or, in the case that a first target character string in the P character strings is not equal to a second target character string in the M character strings, determining that the signature information verification fails, where the position of the first target character string in the P character strings corresponds to the position of the second target character string in the M character strings, and the first target character string is any character string of the P character strings.

The second character string can be segmented to obtain multiple character strings, for example, to obtain r character strings of characters ‘0’ and ‘1’ which each has a length s, and the r character strings can be denoted as f₁, . . . , fᵣ respectively.

For iϵ{1, . . . , r}, if fᵢ=f′ᵢ always holds, the signature information verification succeeds, otherwise the signature information verification fails.

In this implementation, the second character string is segmented to obtain multiple character strings, the multiple character strings are compared with the multiple character strings in the signature information in a one to one manner. In the case that the multiple character strings are always equal to the multiple character strings in the signature information, the signature information verification succeeds, and in the case that a discrepancy is encountered at any character string, the signature information verification fails. In this way, the signature information can be verified very conveniently.

### Third Embodiment

As shown in FIG. 3, the present application provides a digital signature apparatus 300 applied to a first electronic device, including:

a first acquisition module 301, configured to acquire a to-be-sent file and a private key used by the first electronic device for digital signature, where the private key includes a first invertible matrix;

a first generating module 302, configured to generate, based on a randomly generated second invertible matrix and a first tensor, a second tensor isomorphic to the first tensor;
a first digital signature module 303, configured to use a hash function to digitally sign the to-be-sent file based on the second tensor, to obtain a first character string;

a second generating module 304, configured to generate, based on the first character string, the first invertible matrix and the second invertible matrix, signature information provided by the first electronic device for the to-be-sent file.

Optionally, the second generating module 304 is specifically configured to: segment the first character string to obtain P character strings, where P is a positive integer greater than 1; generate a target matrix based on the P character strings, the first invertible matrix and the second invertible matrix; where, the signature information includes the P character strings and the target matrix.

Optionally, the apparatus further includes:

a third generating module, configured to generate, based on the first invertible matrix and the first tensor, a third tensor isomorphic to the first tensor;

a fourth generating module, configured to generate a public key including the first tensor and the third tensor, where the public key corresponds to the private key;

a publishing module configured to publish the public key.

The digital signature apparatus 300 provided in the present application can implement various processes implemented in the digital signature method embodiments, and can achieve the same beneficial effects. To avoid repetition, details are not described herein again.

### Fourth Embodiment

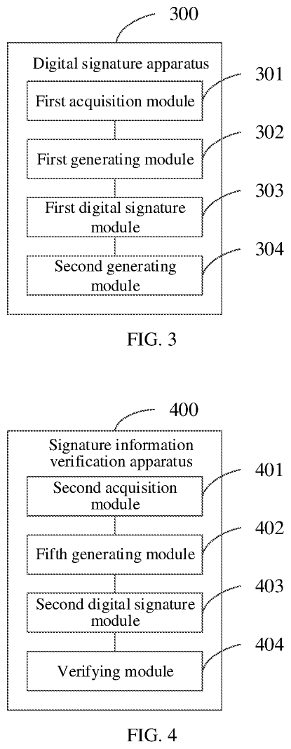

As shown in FIG. 4, the present application provides a signature information verification apparatus 400 applied to a second electronic device, including:

a second acquisition module 401, configured to acquire a to-be-sent file, signature information of the to-be-sent file, and a public key used by the second electronic device to verify the signature information, where the public key corresponds to a private key associated with the signature information, and the public key includes a first tensor and a third tensor;

a fifth generating module 402, configured to generate a fourth tensor based on the signature information and the first tensor and the third tensor included in the public key;

a second digital signature module 403, configured to use a hash function to digitally sign the to-be-sent file based on the fourth tensor, to obtain a second character string;

a verifying module 404, configured to verify the signature information based on the second character string.

Optionally, the signature information includes P character strings, where P is a positive integer greater than 1, and the verifying module 404 is specifically configured to: segment the second character string to obtain M character strings, where P is equal to M; in the case that the P character strings are equal to the M character strings in a one-to-one manner, determine that the signature information verification succeeds; or, in the case that a first target character string in the P character strings is not equal to a second target character string in the M character strings, determine that the signature information verification fails, the position of the first target character string in the P character strings corresponds to the position of the second target character string in the M character strings, and the first target character string is any character string of the P character strings.

The signature information verification apparatus 400 provided in the present application can implement the various processes implemented in the signature information verification method embodiments, and can achieve the same beneficial effects. To avoid repetition, details are not described herein again.

According to embodiments of the present application, the present application further provides an electronic device, a readable storage medium, and a computer program product.

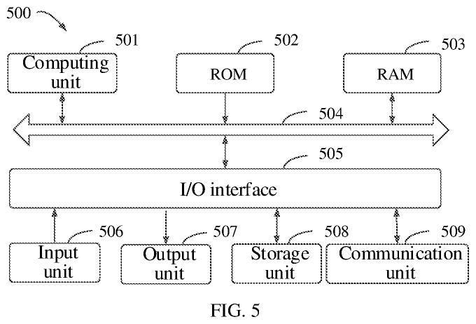

FIG. 5 shows a schematic block diagram of an example electronic device 500 that can be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular phones, smart phones, wearable devices, and other similar computing devices. The components shown here, their connections and relationships, and their functions are merely for illustration, and are not intended to limit the implementation of this application described and/or claimed herein.

As shown in FIG. 5, the device 500 includes a computing unit 501. The computing unit 501 may carry out various suitable actions and processes according to a computer program stored in a read-only memory (ROM) 502 or a computer program loaded from a storage unit 508 into a random access memory (RAM) 503. The RAM 503 may as well store therein all kinds of programs and data required for the operation of the device 500. The computing unit 501, the ROM 502 and the RAM 503 are connected to each other through a bus 504. An input/output (I/O) interface 505 is also connected to the bus 504.

Multiple components in the device 500 are connected to the I/O interface 505. The multiple components include: an input unit 506, e.g., a keyboard, a mouse and the like; an output unit 507, e.g., a variety of displays, loudspeakers, and the like; a storage unit 508, e.g., a magnetic disk, an optical disc and the like; and a communication unit 509, e.g., a network card, a modem, a wireless transceiver, and the like. The communication unit 509 allows the device 500 to exchange information/data with other devices through a computer network, such as the Internet, and/or other telecommunication networks.

The computing unit 501 may be any general purpose and/or special purpose processing components having a processing and computing capability. Some examples of the computing unit 501 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 501 carries out the aforementioned methods and processes, e.g., the digital signature method or signature information verification method. For example, in some embodiments, the digital signature method or signature information verification method may be implemented as a computer software program tangibly embodied in a machine readable medium, such as the storage unit 508. In some embodiments, all or a part of the computer program may be loaded to and/or installed on the device 500 through the ROM 502 and/or the communication unit 509. When the computer program is loaded into the RAM 503 and executed by the computing unit 501, one or more steps of the foregoing digital signature method or signature information verification method may be implemented. Optionally, in other embodiments, the computing unit 501 may be configured in any other suitable manner (e.g., by means of a firmware) to implement the digital signature method or signature information verification method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN), the Internet and a blockchain network.

The computer system can include a client and a server. The client and server are generally remote from each other and typically interact through a communication network. The relationship of client and server arises by virtue of computer programs running on respective computers and having a client-server relationship to each other. The server can be a cloud server, also known as a cloud computing server or a cloud host, which is a host product in the cloud computing service system to solve the defect of difficult management and weak business scalability in traditional physical host and VPS service (“Virtual Private Server”, or “VPS” for short). The server can also be a server of a distributed system, or a server combined with a blockchain.

It is appreciated, all forms of processes shown above may be used, and steps thereof may be reordered, added or deleted. For example, as long as expected results of the technical solutions of the present application can be achieved, steps set forth in the present application may be performed in parallel, performed sequentially, or performed in a different order, and there is no limitation in this regard.

The foregoing specific implementations constitute no limitation on the scope of the present application. It is appreciated by those skilled in the art, various modifications, combinations, sub-combinations and replacements may be made according to design requirements and other factors. Any modifications, equivalent replacements and improvements made without deviating from the spirit and principle of the present application shall be deemed as falling within the scope of the present application.

What is claimed is:

1. A digital signature method, applied to a first electronic device, comprising:
acquiring a to-be-sent file and a private key used by the first electronic device for digital signature, wherein the private key comprises a first invertible matrix;
generating, based on a randomly generated second invertible matrix and a first tensor, a second tensor isomorphic to the first tensor;
using a hash function to digitally sign the to-be-sent file based on the second tensor to obtain a first character string; and
generating, based on the first character string, the first invertible matrix and the second invertible matrix, signature information provided by the first electronic device for the to-be-sent file.

2. The digital signature method according to claim 1, wherein generating the signature information provided by the first electronic device for the to-be-sent file further comprises:
segmenting the first character string to obtain P character strings, wherein P is a positive integer greater than 1;
generating a target matrix based on the P character strings, the first invertible matrix and the second invertible matrix; and
wherein the signature information comprises the P character strings and the target matrix.

3. The digital signature method according to claim 1, wherein, before the acquiring the to-be-sent file and the private key used by the first electronic device for digital signature, the method further comprises:
generating, based on the first invertible matrix and the first tensor, a third tensor isomorphic to the first tensor;
generating a public key comprising the first tensor and the third tensor, wherein the public key corresponds to the private key; and
publishing the public key.

4. A signature information verification method, applied to an electronic device, comprising:
acquiring a to-be-sent file, signature information of the to-be-sent file, and a public key used by the electronic device to verify the signature information, wherein the public key corresponds to a private key associated with the signature information, and the public key comprises a first tensor and a third tensor;
generating a fourth tensor based on the signature information and the first tensor and the third tensor of the public key;
using a hash function to digitally sign the to-be-sent file based on the fourth tensor to obtain a second character string; and
verifying the signature information based on the second character string.

5. The signature information verification method according to claim 4, wherein the signature information comprises P character strings, wherein P is a positive integer greater than 1, and the verifying the signature information based on the second character string comprises:
segmenting the second character string to obtain M character strings, wherein P is equal to M;
in a case that the P character strings are equal to the M character strings in a one-to-one manner, determining that the signature information verification succeeds; or, in a case that a first target character string in the P character strings is not equal to a second target character string in the M character strings, determining that the signature information verification fails, wherein a position of the first target character string in the P character strings corresponds to a position of the second target character string in the M character strings, and the first target character string is any character string of the P character strings.

6. An electronic device, comprising:
at least one processor; and
a memory communicatively connected to the at least one processor; wherein,
the memory stores instructions executable by the at least one processor, and the instructions are executed by the at least one processor to implement a digital signature method comprising:
acquiring a to-be-sent file and a private key used by the electronic device for digital signature, wherein the private key comprises a first invertible matrix;
generating, based on a randomly generated second invertible matrix and a first tensor, a second tensor isomorphic to the first tensor;
using a hash function to digitally sign the to-be-sent file based on the second tensor to obtain a first character string; and
generating, based on the first character string, the first invertible matrix and the second invertible matrix, signature information provided by the electronic device for the to-be-sent file.

7. The electronic device according to claim 6, wherein generating the signature information provided by the electronic device for the to-be-sent file further comprises:
segmenting the first character string to obtain P character strings, wherein P is a positive integer greater than 1;
generating a target matrix based on the P character strings, the first invertible matrix and the second invertible matrix; and
wherein the signature information comprises the P character strings and the target matrix.

8. The electronic device according to claim 6, wherein, before the acquiring the to-be-sent file and the private key used by the electronic device for digital signature, the method further comprises:
generating, based on the first invertible matrix and the first tensor, a third tensor isomorphic to the first tensor;
generating a public key comprising the first tensor and the third tensor, wherein the public key corresponds to the private key; and
publishing the public key.

9. An electronic device, comprising:
at least one processor; and
a memory communicatively connected to the at least one processor; wherein,
the memory stores instructions executable by the at least one processor, and the instructions are executed by the at least one processor, such that the at least one processor implements the method according to claim 4.

10. The electronic device according to claim 9, wherein the signature information comprises P character strings, P is a positive integer greater than 1, and the verifying the signature information based on the second character string comprises:
segmenting the second character string to obtain M character strings, wherein P is equal to M;
in a case that the P character strings are equal to the M character strings in a one-to-one manner, determining that the signature information verification succeeds; or, in a case that a first target character string in the P character strings is not equal to a second target character string in the M character strings, determining that the signature information verification fails, wherein a position of the first target character string in the P character strings corresponds to a position of the second target character string in the M character strings, and the first target character string is any character string of the P character strings.

11. A non-transitory computer readable storage medium storing therein a computer instruction, wherein the computer instruction is configured to cause a computer to implement the method according to claim 1.

12. A non-transitory computer readable storage medium storing therein a computer instruction, wherein the computer instruction is configured to cause a computer to implement the method according to claim 4.

13. A computer program product, when the computer program product is run on an electronic device, the electronic device implements the method according to claim 1.

14. A computer program product, when the computer program product is run on an electronic device, the electronic device implements the method according to claim 4.
